(19) United States
(12) Patent Application Publication
(10) Pub. No.: US 2009/0260767 A1
(43) Pub. Date: Oct. 22, 2009

(54) USE OF HYDROPHOBIC DYES TO MONITOR HYDROPHOBIC CONTAMINANTS IN A PAPERMAKING PROCESS

(75) Inventors: Alessandra Gerli, Leiden (NL); Laura M. Sherman, Naperville, IL (US); Michael J. Murcia, DeKalb, IL (US)

Correspondence Address: NALCO COMPANY, 1601 W. DIEHL ROAD, NAPERVILLE, IL, 60563-1198, US

(73) Assignee: EVERY PENNY COUNTS, INC., Sarasota, FL (US)

(21) Appl. No.: 12/405,807

(22) Filed: Mar. 17, 2009

Related U.S. Application Data
(63) Continuation-in-part of application No. 11/582,603, filed on Oct. 18, 2006, now abandoned.
Application No. 11/582,603 is a continuation of application No. 10/823,850, filed on Apr. 14, 2004, now Pat. No. 7,264,153.
(60) Provisional application No. 60/462,732, filed on Apr. 14, 2003.

(51) Int. Cl. G01J 3/46; D21C 9/08

(52) U.S. Cl. 162/49

(57) ABSTRACT

A method of monitoring and controlling one or more types of hydrophobic contaminants in a papermaking process is disclosed. The methodology utilizes the measurement of hydrophobic dyes, which are capable of fluorescing and interacting with the hydrophobic contaminants. In addition, a method of determining the relative size of the hydrophobic contaminants is disclosed as well.

### FIELD OF THE INVENTION

This invention pertains to the measurement and control of hydrophobic contaminants.

### BACKGROUND OF THE INVENTION

Hydrophobic/organic contaminants, such as natural pitch, stickies, tackies and white pitch are major obstacles in paper manufacturing because these materials when liberated during a papermaking process can become both undesirable components of papermaking furnishes and troublesome to the mill equipment by preventing proper operation of mechanical parts when these materials deposit.

Increased use of secondary fiber, coated broke and mechanical pulp in the papermaking process contributes to the accumulation of organic contaminants. These contaminants can form deposits that affect machine runnability and final product quality. Control of the contaminants is typically managed through chemical fixation, and its effectiveness is therefore dependent on the ability to determine the proper program and application. Historically, a common method used to assess program performance has been filtrate turbidity reduction. This method, however, is not entirely adequate because it often yields an incomplete picture of the furnish demands from hydrophobic particles. More recently, flow cytometry has been used in the industry for monitoring hydrophobic contaminants. Disadvantages of this method are that it is both labor and capital intensive.

A rapid and accurate method of measuring organic contaminants is therefore desired. Chemical control programs are often used to passivate or remove deposit-forming contaminants. For that reason, a method of screening the efficacy of chemical treatments that reduce the overall content of hydrophobic contaminants in a papermaking process is also desired.

### BRIEF DESCRIPTION OF THE DRAWINGS

FIG. 1 shows pulp samples collected from various locations across the wet end of a paper machine as indicated. The results indicate that turbidity and hydrophobicity, or contaminant presence, do not necessarily track each other.

FIG. 2 shows the hydrophobicity of untreated and treated coated broke filtrate filtered through various size media of 0.8, 3, 5, 10, and 76 microns.

FIG. 3 shows that different fixatives respond to the coated broke differently. Although different fixatives can achieve the same turbidity, the hydrophobicity varies greatly among the samples.

### SUMMARY OF THE INVENTION

The present invention provides for a method of monitoring one or more types of hydrophobic contaminants in a papermaking process comprising: (a) obtaining a sample of fluid from said papermaking process; (b) selecting a hydrophobic dye that is capable of interacting with said contaminants in said fluid and fluorescing in said fluid; (c) adding said dye to said fluid and allowing a sufficient amount of time for said dye to interact with said contaminants in said fluid; (d) measuring the fluorescence of the dye in said fluid; (e) correlating the fluorescence of the dye with the concentration of said contaminants; and (f) optionally controlling the amount of one or more chemicals that reduce or inactivate said contaminants which are added to said papermaking process.

The present invention also provides for a method of measuring the effectiveness of one or more chemicals that decrease the amount of one or more hydrophobic contaminants in a papermaking process: (a) monitoring one or more types of contaminants in a papermaking process comprising: obtaining a sample of fluid from said papermaking process; selecting a hydrophobic dye that is capable of interacting with said contaminants in said fluid and fluorescing in said fluid; adding said dye to said fluid and allowing a sufficient amount of time for said dye to interact with said contaminants in said fluid; measuring the fluorescence of the dye in said fluid; and correlating the fluorescence of the dye with the concentration of said contaminants; (b) adding one or more chemicals to said papermaking process that decrease the amount of said hydrophobic contaminants in said papermaking process; (c) re-measuring the amount of contaminants in said papermaking process by performing step (a) at least one more time; and (d) optionally controlling the amount of said chemicals that are added to said papermaking process.

The present invention also provides for a method of monitoring one or more hydrophobic contaminants and determining the size of said hydrophobic contaminants in a papermaking process comprising: (a) obtaining a sample of fluid from said papermaking process; (b) selecting a hydrophobic dye that is capable of interacting with said contaminants in said fluid and fluorescing in said fluid; (c) adding said dye to said fluid and allowing a sufficient amount of time for said dye to interact with said contaminants in said fluid; (d) measuring the fluorescence of the dye in said fluid; (e) correlating the fluorescence of the dye with the concentration of said contaminants; (f) passing the sample measured in step (d) through a medium capable of separating the sample into one or more aqueous fractions at least one time; (g) measuring the fluorescence of the aqueous fractions from step (f) of said sample at least one time; (h) determining the size of the hydrophobic contaminants of the aqueous fractions; (i) optionally correlating the fluorescence of the dye in the aqueous fractions with the concentration of said hydrophobic contaminants in the aqueous fractions; and optionally controlling the amount of one or more chemicals that reduce or inactivate said contaminants which are added to said papermaking process.

The present invention also provides for a method of monitoring one or more hydrophobic contaminants and determining the size of said hydrophobic contaminants in a papermaking process comprising: (a) obtaining a sample of fluid from said papermaking process; (b) selecting a hydrophobic dye that is capable of interacting with said contaminants in said fluid and fluorescing in said fluid; (c) adding said dye to said fluid and allowing a sufficient amount of time for said dye to interact with said contaminants in said fluid; (d) measuring the fluorescence of the dye in said fluid; (e) correlating the fluorescence of the dye with the concentration of said contaminants; (f) filtering the sample measured in step (d) at least one time through at least one filter, wherein the filter has one or more pores with a known pore size; (g) measuring the fluorescence of the filtrate from step (f) of said sample at least one time; (h) determining the size of the hydrophobic contaminants of the filtrate and optionally a concentrate from said filtration step; (i) optionally correlating the fluorescence of the dye in the filtrate and/or reject with the concentration of said hydrophobic contaminants in the filtrate; and

j) optionally controlling the amount of one or more chemicals that reduce or inactivate said contaminants which are added to said papermaking process.

### DETAILED DESCRIPTION OF THE INVENTION

“Papermaking process” means a method of making any kind of paper products (e.g. paper, tissue, board, etc.) from pulp comprising forming an aqueous cellulosic papermaking furnish, draining the furnish to form a sheet and drying the sheet. The steps of forming the papermaking furnish, draining and drying may be carried out in any manner generally known to those skilled in the art. The papermaking process may include a pulping stage, e.g. making pulp from woody raw material and bleaching stage, e.g. chemical treatment of the pulp for brightness improvement, Furnishes can contain fillers and/or other contaminants.

“Bulk sample” means a sample whose constituents have not been specifically separated, except bulk sample may include, a separation based upon size. For example, bulk sample does not include separating e.g. a resin particle from a suspension.

“Solvatochromatic dye” is a dye that has a shifting absorbance and/or fluorescence emission wavelength depending on the polarity of its surroundings.

“Fluid” includes an aqueous papermaking suspension from a papermaking process, e.g. a fluid containing fibers in a pulping stage, a thin stock, a thick stock, aqueous suspensions drawn from the papermaking process, e.g. various locations from a papermaking machine or pulping process, aqueous fluid in a uhl box, press dewatering section, and/or any part of the papermaking process that one of ordinary skill in the art can think of where one would need to monitor hydrophobic contaminants.

As stated above, the present invention provides for a method of monitoring one or more types of hydrophobic contaminants in a papermaking process via the use of fluorescence.

The hydrophobic dyes, which are added to the sample, must be able to stain or interact with the hydrophobic contaminants, e.g. pitch particles.

In one embodiment, a method of monitoring hydrophobic dyes consists essentially of the above stated elements.

In another embodiment, the fluid is an aqueous filtrate of a pulp slurry.

In another embodiment, the turbidity of the fluid is also measured. In a further embodiment, the turbidity of said fluid is measured before and after the addition of said chemicals.

In another embodiment, the fluid is filtered or diluted or a combination thereof prior to said addition of said dye or said fluorescent measurement of said dye, wherein said filtering or dilution of said fluid permits said fluid to be fluorometrically monitored.

In another embodiment, the sample is taken from a dilute sample point off a papermaking process, e.g. a paper machine. In a further embodiment, the sample point is the white water of a papermaking process. The reasoning postulated for this collection/sample point is that there is no long fiber present/substantially any fiber present, and filtration may not be necessary.

In another embodiment, one or more samples undergo a sieving/separation step to separate the long fiber from the suspended contaminants in a sample solution. For example, the degree of dilution that the filtrate/aqueous fraction undergoes from the separation process relies on two main factors, both relating to turbidity. If the filtrate/aqueous fraction is too turbid for the turbidimeter, dilution is required to bring the turbidity into a measurable range for the meter. This is the case unless you want a less accurate and “quick and dirty” test, which is one embodiment of the claimed invention.

In another embodiment, if the turbidity is above 2000 NTU (nephelometric turbidity units), then it is a preferred embodiment that a sample from a papermaking process is diluted/further separated prior to the addition of a dye and fluorescent measurement. The value of 2000 NTU may be instrument or measurement technique dependent.

In another embodiment, the dye is selected from the group consisting of: 9-diethylamino-5H-benzo[alpha]phenoxazine-5-one, 1-dimethylamino-5-sulfamoyl-naphthalene, pyrene, 1-pyrenecarbaldehyde, Reichardt's dye, 4-aminophthalimide, 4-(N,N-dimethylamino)phthalimide, bromonapthalene, 2-(dimethylamino)naphthalene, and a combination thereof.

In another embodiment, the dye is a solvatochromatic dye.

In another embodiment, the dye does not include N-(n-butyl)-4-(n-butylamino)-naphthalimide.

In another embodiment, the fluid is obtained from a wet end of said papermaking process.

As stated above, the dye added to a sample must have a sufficient amount of time for said dye to interact with said contaminants in said fluid prior to its fluorescent measurement. One of ordinary skill in the art could determine a sufficient amount of time for said interaction without undue experimentation.

In one embodiment, the dye is mixed with a solvent prior to its addition to said fluid. One of ordinary skill in the art could determine an adequate time for mixing without undue experimentation.

In another embodiment, the contaminants are selected from the group consisting of: pitch, fiber, filler, fines, coated broke, mill broke, recycle, groundwood, thermal mechanical pulp, chemi-thermal mechanical pulp, chemical pulp, deinked pulp, ink, adhesives, stickies, tackies, waxes, binders and dissolved and/or colloidal substances, and a combination thereof.

In another embodiment, the method is an on-line method and/or batch sample method.

In another embodiment, the fluorometric measurement is performed at a pre-set basis, intermittent basis, and/or continuous basis. For example, a flow cell can be utilized as a means for measuring the fluorescence of said hydrophobic contaminants. More specifically, in one embodiment, a process for measurement comprises: the addition of one or more fluorescent tracers to a sample obtained from a papermaking process prior to its fluorescent measurement in said flow cell. One of ordinary skill in the art would be able to carry out this process without undue experimentation. For example, one could utilize flow injection analysis and/or sequence injection analysis techniques to carry out the above-referenced measurement protocol.

In another embodiment, the fluorometric measurement is performed with a handheld fluorometer. A fluorescent measurement may be carried out with other types of fluorometers.

The present invention also provides for a method of measuring the effectiveness of one or more chemicals that decrease the amount of one or more hydrophobic contaminants in a papermaking process. The information on the amount of hydrophobic contaminants in a fluid can be utilized to form a control loop for the addition of one or more chemicals, which can be used to control the amount of hydrophobic contaminants.

In one embodiment the methodology for monitoring the hydrophobic contaminants can be measured by the above-stated fluorescence methodology and its various embodiments.

In another embodiment, a determination of the amount of fluorescence is measured by the above-mentioned protocol, then subsequent to this step, an addition of one or more chemicals to the papermaking process to treat the hydrophobic contaminants, e.g. increase/decrease in the same chemistry for hydrophobic contaminant inhibition or change in the chemistry treatment program for hydrophobic contaminant inhibition, and then subsequent to the treatment step, a re-measurement of the amount of contaminants in said papermaking process by the above-mentioned protocol.

In another embodiment, the chemicals are at least one of the following: a fixative; a detackifier; a dispersant; a surfactant, and a retention aid.

The present invention also provides for a method of monitoring hydrophobic contaminants and determining the size of said hydrophobic contaminants in a papermaking process.

In one embodiment, the methodology for monitoring the hydrophobic contaminants can be measured by the above-stated fluorescence methodology and its various embodiments.

In another embodiment, the aqueous fractions contain one or more suspended solids or one or more particles.

In another embodiment, the medium capable of separating is a centrifuge, a filter or a combination thereof.

Various types of apparatuses/techniques, filters can be utilized, e.g. with various pore sizes, can be utilized to separate components based upon size.

### EXAMPLE SECTION

### A. Standard Testing Procedure

### Fluorescence Measurement of Coated Broke Filtrate

I. Equipment: Turner Designs Aquafluor® fluorometer unit with green optic channel (A) was utilized.
II. Calibration: The Aquafluor fluorometer unit is calibrated by measuring the fluorescence value of a solution containing 30 ppm of nile red dye in alcohol (3 microliters of the 0.01 wt % nile red dye solution in 3 mls of alcohol). This fluorescence emission is set to 600 units on the instrument and the fluorescence emission of de-ionized water was measured and used as the ‘blank’.
III. Coated Broke Treatment: After performing the coated broke treatment test as described in the table, (the Britt jar propeller is used for mixing the broke) the filtrate is diluted to obtain an on-scale turbidity reading.

### Coated Broke Treatment Test Parameters

Timing Sequence

| | |
|---|---|
| t = 0 | Start |
| t = 10 | Add Coagulant |
| t = 30 | Stop & Filter |

Collect filtrate for 60 seconds and record mass
Settings
150 g Sample @ ~3.5 wt %
500 rpm
100 mesh screen (3″ dia)
Make appropriate dilution of the filtrate for turbidity reading

IV. Fluorescence Measurement:
   1. After the turbidity of the dilute solution is read, place 3 mls of dilute coated broke filtrate into disposable cuvette and turn Aquafluor unit on.
   2. Wipe exterior of cuvette with non-abrasive wipe, place cuvette into Aquafluor unit, close lid, press the read button, and record the background fluorescence.
   3. Add 6 microliters of 0.01% nile red dye solution in alcohol to cuvette. Mix well. Wipe exterior of cuvette with non-abrasive wipe.
   4. Place cuvette into Aquafluor unit, close lid, press the read button, and record the raw fluorescence measurement result.
   5. When finished, discard sample. Throw out cuvette if unable to wash out.
   6. Repeat for all samples.
   7. Subtract the background fluorescence from the sample fluorescence to obtain the corrected fluorescence.
V. Data Analysis: The data can be plotted various ways including:
   1. % Reduction in Hydrophobicity (fluorescence reduction) vs. polymer dose;
   2. Turbidity vs. fluorescence for each dosage curve

### B. Examples

The following examples utilize the above referenced “Standard Testing Procedure” for fluorescence measurements.

### Example 1

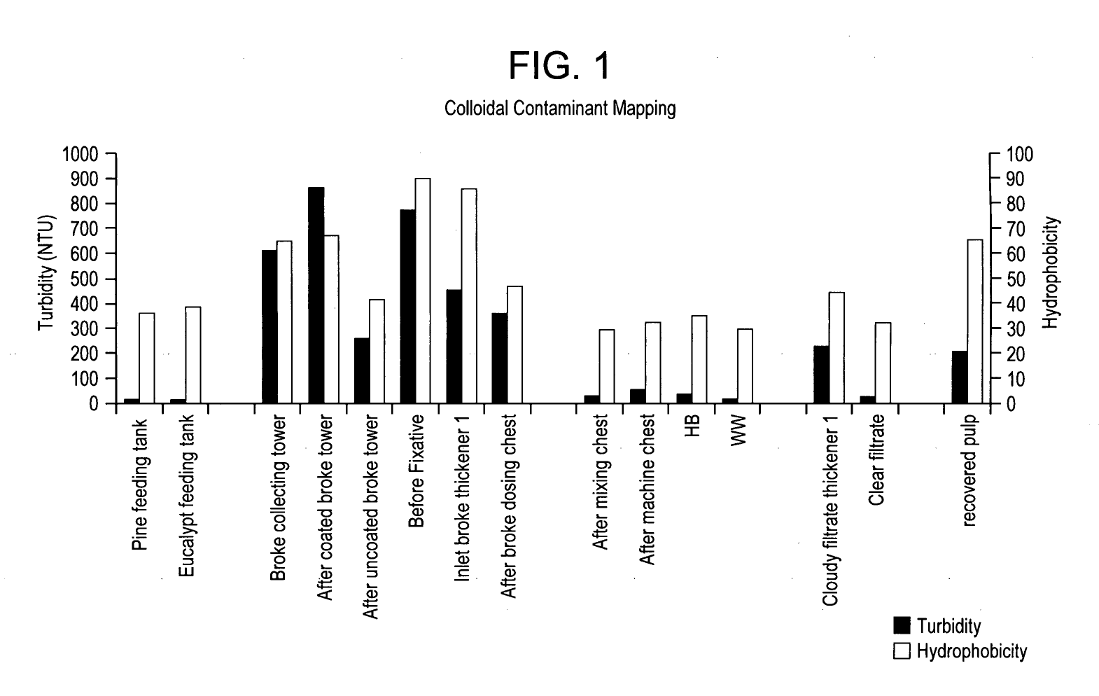

Pulp samples were collected from various locations across the wet end of the paper machine as indicated in the figure. The long fibers were removed from the sample by passing the sample through a 150-micron sieve. Turbidity of the filtrate was measured, followed by a fluorescence measurement on the filtrate after adding 6 microliters of 0.01 wt % nile red dye in alcohol to 3 milliliters of the filtrate. The results, as shown in FIG. 1, indicate that turbidity and hydrophobicity, or contaminant presence do not necessarily track each other.

### Example 2

Preparation of coated broke: The coated broke was prepared from dry coated paper cut into 1.5 by 1.5 inch squares. 140 g of dry coated broke was soaked for 20 minutes in 3,860 ml of synthetic tap water for a target consistency of 3.5 wt %. The sample was then transferred to a four-liter capacity Adirondack Pulper and repulped at setting 5 for 90 minutes.

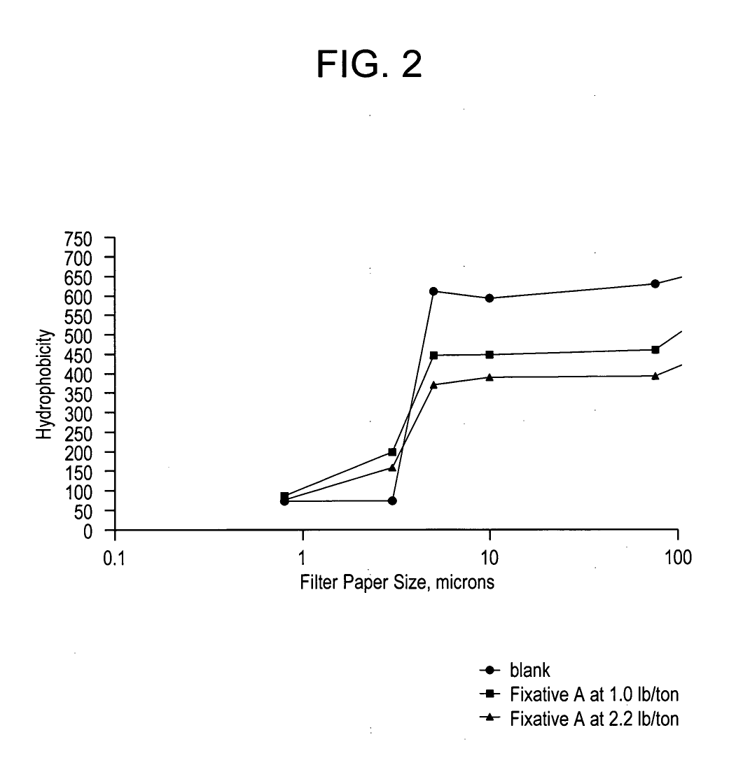

FIG. 2 shows the hydrophobicity of untreated and treated coated broke filtrate filtered through various size media of 0.8, 3, 5, 10, and 76 microns. The fluorescence measured on each of the filtrates provides an indication of which particle size region contains the highest level of hydrophobic particles. The figure also indicates that there is no agglomeration of the white pitch upon addition of fixative. The fixative lowers the overall hydrophobicity while maintaining the particle size distribution profile.

### Example 3

This hydrophobicity test method was used to evaluate potential treatment programs for a coated broke sample.

### Test Procedure:

1. Prepare fixative solutions at 0.3 to 0.5 weight-percent as product.
2. Set mixing Britt jar mixing at 500 rpm
3. Add 200 mL of coated broke to the 400 mL-beaker.
4. Insert Britt Jar propeller into broke, turn Britt Jar mixer on, and at the same time start stop watch.
5. Add coagulant using the following mixing sequence:
t=0, start mixer
t=10 seconds, add coagulant
t=30 seconds, stop mixer, stop and reset stopwatch.
6. Pour the whole treated stock into the 100-mesh sieve supported on a 400 mL beaker and start stop watch. When filtration is completed, remove sieve from beaker and monitor time of filtration.
7. Measure turbidity of the filtrate by using a turbidity meter. If the filtrate turbidity is out of range, dilute filtrate. The same dilution must be applied to each of the filtrates from the polymer-dosed stocks in order to evaluate relative polymer performance.
8. Take 3 ml of diluted filtrate and add 3 microliters of 0.01 wt % nile red dye in alcohol and measure the fluorescence.
9. Repeat steps 3 through 8 with no polymer treatment (blank).

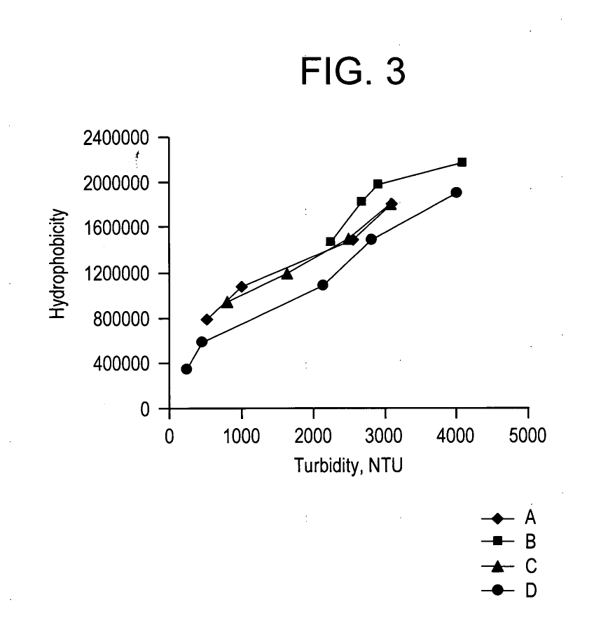

FIG. 3 demonstrates that different fixatives respond to the coated broke differently. Although the same turbidity can be achieved by different fixatives, the hydrophobicity varies greatly among the samples.

1. A method of monitoring one or more types of hydrophobic contaminants in a papermaking process comprising:
a. obtaining a sample of fluid from said papermaking process;
b. selecting a hydrophobic dye that is capable of interacting with said contaminants in said fluid and fluorescing in said fluid;
c. adding said dye to said fluid and allowing a sufficient amount of time for said dye to interact with said contaminants in said fluid;
d. measuring the fluorescence of the dye in said fluid;
e. correlating the fluorescence of the dye with the concentration of said contaminants; and
f. optionally controlling the amount of one or more chemicals that reduce or inactivate said contaminants which are added to said papermaking process.

2. The method of claim 1 wherein said sample is a bulk sample.

3. The method of claim 1 further comprising: measuring the turbidity of said fluid, optionally wherein said turbidity of said fluid is measured before and after the addition of said chemicals.

4. The method of claim 1, wherein said fluid is filtered or diluted or a combination thereof prior to said addition of said dye or said fluorescent measurement of said dye.

5. The method of claim 1, wherein said dye is selected from the group consisting of: 9-diethylamino-5H′-benzo[alpha]phenoxazine-5-one, 1-dimethylamino-5-sulfamoyl-naphthalene, pyrene, 1-pyrenecarbaldehyde, Reichardt's dye, 4-aminophthalimide, 4-(N,N-dimethylamino)phthalimide, bromonapthalene, 2-(dimethylamino)naphthalene, and a combination thereof.

6. The method of claim 1, wherein said dye does not include N-(n-butyl)-4-(n-butylamino)-naphthalimide.

7. The method of claim 1, wherein said dye is a solvatochromatic dye.

8. The method of claim 1 wherein said fluid is obtained from a wet end of said papermaking process.

9. The method of claim 1, wherein said contaminants are selected from the group consisting of: pitch, fiber, filler, fines, coated broke, mill broke, recycle, groundwood, thermal mechanical pulp, chemi-thermal-mechanical pulp, chemical pulp, deinked pulp, ink, adhesives, stickies, tackies, waxes, binders and dissolved and/or colloidal substances, and a combination thereof.

10. The method of claim 1, wherein said method is an on-line method and/or batch sample method.

11. The method of claim 1, wherein said fluorometric measurement is performed at a pre-set basis, intermittent basis, and/or continuous.

12. The method of claim 1, wherein said fluorometric measurement is performed with a handheld fluorometer.

13. The method of claim 1, wherein said fluid is an aqueous filtrate of a pulp slurry.

14. A method of measuring the effectiveness of one or more chemicals that decrease the amount of one or more hydrophobic contaminants in a papermaking process:
a. monitoring one or more types of contaminants in a papermaking process comprising: obtaining a sample of fluid from said papermaking process; selecting a hydrophobic dye that is capable of interacting with said contaminants in said fluid and fluorescing in said fluid; adding said dye to said fluid and allowing a sufficient amount of time for said dye to interact with said contaminants in said fluid; measuring the fluorescence of the dye in said fluid; and correlating the fluorescence of the dye with the concentration of said contaminants;
b. adding one or more chemicals to said papermaking process that decrease the amount of said hydrophobic contaminants in said papermaking process;
c. re-measuring the amount of contaminants in said papermaking process by performing step (a) at least one more time; and
d. optionally controlling the amount of said chemicals that are added to said papermaking process.

15. The method of claim 14, wherein said chemicals are at least one of the following: a fixative; a detackifier; a dispersant; a surfactant; and a retention aid.

16. A method of monitoring one or more hydrophobic contaminants and determining the size of said hydrophobic contaminants in a papermaking process comprising:
a. obtaining a sample of fluid from said papermaking process;
b. selecting a hydrophobic dye that is capable of interacting with said contaminants in said fluid and fluorescing in said fluid;
c. adding said dye to said fluid and allowing a sufficient amount of time for said dye to interact with said contaminants in said fluid;
d. measuring the fluorescence of the dye in said fluid;
e. correlating the fluorescence of the dye with the concentration of said contaminants;
f. passing the sample measured in step (d) through a medium capable of separating the sample into one or more aqueous fractions at least one time;
g. measuring the fluorescence of the aqueous fractions from step (f) of said sample at least one time;
h. determining the size of the hydrophobic contaminants of the aqueous fractions;
i. optionally correlating the fluorescence of the dye in the aqueous fractions with the concentration of said hydrophobic contaminants in the aqueous fractions; and
j. optionally controlling the amount of one or more chemicals that reduce or inactivate said contaminants which are added to said papermaking process.

17. The method of claim 16, wherein said aqueous fractions contain one or more suspended solids or one or more particles.

18. The method of claim 16, wherein the medium capable of separating is a centrifuge, a filter or a combination thereof.

19. A method of monitoring one or more hydrophobic contaminants and determining the size of said hydrophobic contaminants in a papermaking process comprising:
a. obtaining a sample of fluid from said papermaking process;
b. selecting a hydrophobic dye that is capable of interacting with said contaminants in said fluid and fluorescing in said fluid;
c. adding said dye to said fluid and allowing a sufficient amount of time for said dye to interact with said contaminants in said fluid;
d. measuring the fluorescence of the dye in said fluid;
e. correlating the fluorescence of the dye with the concentration of said contaminants;
f. filtering the sample measured in step (d) at least one time through at least one filter, wherein the filter has one or more pores with a known pore size;
g. measuring the fluorescence of the filtrate from step (f) of said sample at least one time;
h. determining the size of the hydrophobic contaminants of the filtrate and optionally a concentrate from said filtration step;
i. optionally correlating the fluorescence of the dye in the filtrate and/or reject with the concentration of said hydrophobic contaminants in the filtrate; and
j. optionally controlling the amount of one or more chemicals that reduce or inactivate said contaminants which are added to said papermaking process.
